(19) United States
(12) Patent Application Publication
(10) Pub. No.: US 2007/0255638 A1
(43) Pub. Date: Nov. 1, 2007

(54) System and method for allocating investor wealth to at least one risky asset and life insurance

(76) Inventors: Peng Chen, Elmhurst, IL (US); Roger G. Ibbotson, Hamden, CT (US); Moshe A. Milevsky, Toronto (CA); Xingnong K. Zhu, Chicago, IL (US)

Correspondence Address: PATENT GROUP;C/O DLA PIPER US LLP, 203 N. LASALLE ST., SUITE 1900, CHICAGO, IL, 60601, US

(21) Appl. No.: 11/415,336

(22) Filed: May 1, 2006

(51) Int. Cl. G06Q 40/00

(52) U.S. Cl. 705/36 R

(57) ABSTRACT

A system and method for allocating an investor's wealth to at least one risky asset and life insurance includes retrieving a profile of the investor. The financial capital available to the investor and a human capital value for the investor are determined. An objective function value for the investor is determined and maximized. An amount of the investor's wealth is allocated to the at least one risky asset and to life insurance.

### FIELD OF THE INVENTION

The invention general relates to financial planning, more particularly, to a system, method and medium of financial analysis utilizing parameters including asset allocation, human capital and life insurance demand.

### BACKGROUND

An important decision that confronts investors is the allocation of their wealth either towards the purchase of life insurance or towards the acquisition of assets to provide savings and financial growth for their retirement years. This allocation of wealth is often governed by an investor's human capital since human capital affects both asset allocation and the demand for life insurance. However, these two important financial decisions have consistently been analyzed separately in theory and practice. Financial planners and advisors have recently begun to recognize that human capital must be taken into account when building financial portfolios for individual investors.

Life insurance has long been used to hedge against mortality risk (i.e., the loss of human capital in the unfortunate event of premature death), a unique aspect of an investor's human capital. Life insurance is the business of human capital securitization—addressing the uncertainties and inadequacies of an individual's human capital (Ostaszewski, K., “Is Life Insurance a Human Capital Derivatives Business?” Journal of Insurance Issues, 26, 1, 1-14 (2003)). On the other hand, empirical studies on life insurance adequacy have shown that under insurance is prevalent. Gokhale and Kotlikoff argue that questionable financial advice, inertia, and the unpleasantness of thinking about one's death are the likely causes (Gokhale, J. and Kotlikoff, L. J.; “The Adequacy of Life Insurance, Reasearch Dialogue,” TIAA CREF INSTITUTE, Issue no. 72 (July 2002), www.tiaa-crefinstitute.org).

Typically, the greater the value of human capital, the more life insurance the family demands. In fact, popular investment and financial planning advice regarding how much life insurance one should acquire is seldom framed in terms of the level of risk associated with one's human capital. Conversely, asset allocation decisions are only recently being framed in terms of the risk characteristics of human capital, and rarely is it integrated with life insurance decisions.

Economic theory predicts that investors make asset allocation and life insurance purchase decisions to maximize their lifetime utilities of wealth and consumption. An investor's total wealth typical includes two parts: (1) readily tradable financial assets, and (2) human capital. Although human capital is not readily tradable, it is often an investor's single largest asset. As illustrated in FIG. 1, younger investors typically have far more human capital than financial capital because younger investors have a greater number of years to work and have had few years to save and accumulate financial wealth. Conversely, older investors tend to have more financial capital than human capital, since they have fewer years ahead to work, but have accumulated financial capital. This changing mix of financial capital and human capital impacts investors' decisions regarding financial asset allocation.

In the late 1960s, economists established models that implied individuals should optimally maintain constant portfolio weights throughout their life cycle (Samuelson, P., “Life Time Portfolio Selection by Dynamic Stochastic Programming,” Review of Economics and Statistics, Vol. 51, 239-246 (1969); Merton, R., “Life Time Portfolio Selection Under Uncertainty: The Continuous Time Case,” Review of Economics and Statistics, Vol. 51, 247-257 (1969)). Those models incorrectly assumed investors had no labor income (i.e., human capital). However in contrast to such models, when labor income is included in the portfolio choice model, individuals will optimally change their allocation of financial assets in a pattern related to their position in their life cycle. In other words, optimal asset allocation depends on the risk-return characteristics and flexibility of the labor income (such as how much or how long the investor works). Thus, the investor has the ability to adjust the financial portfolio to compensate for the non-tradable human capital risk exposures (e.g., Merton, R., “Optimum Consumption and Portfolio Rules in a Continuous-Time Model,”Journal of Economic Theory, 3(4), 373-413, (December 1971); Bodie, Z., Merton, R., and Samuelson, W., “Labor supply flexibility and portfolio choice in a life cycle model,” Journal of Economic Dynamics and Control, Vol. 16, 427-449 (1992); Heaton, J., and Lucas, D. “Market Frictions, Savings Behavior, and Portfolio Choice,” Macroeconomic-Dynamics, 1(1): 76-101 (1997); Jaganathan, R., and Kocherlacota, N., “Why Should Older People Invest Less in Stocks Than Younger People?” Federal Reserve Bank of Minneapolis Quarterly Review, 20(3):11-23, Summer (1996); and Campbell, J., and Viceira, L., “Strategic Asset Allocation—Portfolio Choice for Long-term Investors,” Oxford University Press (2002)). Several key theoretical implications with respect to risk-return characteristics and the flexibility of the labor income include: 1) young investors will invest more in risky assets (e.g. stocks) than older investors; 2) investors with safe labor income and thus, safe human capital will invest more of their financial portfolio into stocks; 3) investors with labor income highly correlated with stock markets will invest their financial assets into less risky assets; and 4) the ability to adjust labor supply (i.e., higher flexibility) also increases an investor's allocation toward risky assets. However, empirical studies show that most investors do not efficiently diversify their financial portfolio considering the risk of their human capital. In fact, many investors use primitive methods to determine the asset allocation and many of them invest very heavily into the stock of the company for which they work. Benartzi, S., “Excessive Extrapolation and the Allocation of 401(k) Accounts to Company Stock,” Journal of Finance, 56, 1747-64 (2001) and Benartzi, S., and Thaler, R., Naïve Diversification Strategies in Defined Contribution Saving Plans,” American Economic Review, 91, 79-98 (2001)

Additionally, the lifetime consumption and portfolio decision models in the art need to be expanded to take into account lifetime uncertainty (or mortality risk). Life insurance and life annuities may be used to insure against lifetime uncertainty, while also deriving conditions under which consumers would fully insure against lifetime uncertainty. (Yaari, M. E., “Uncertain Lifetime, Life Insurance, and the Theory of the Consumer,” The Review of Economic Studies, Vol. 32, No. 2, 137-150 (1965)).

Theoretical studies have shown a link between the demand for life insurance and the uncertainty of human capital. For most households, labor income uncertainty dominates financial capital income uncertainty. Solutions have been developed where the optimal amount of insurance a household should purchase is based on human capital uncertainty. (Campbell, R. A, “The Demand for Life Insurance: An Application of the Economics of Uncertainty,” The Journal of Finance, Vol. 35, No. 5, 1155-1172 (1980)). For example, model life insurance demand in a portfolio context can be determined using mean-variance analysis, deriving the optimal insurance demand and the optimal allocation between risky and risk-free assets where the optimal amount of insurance depends on two components: the expected value of human capital and the risk-return characteristics of the insurance contract (Buser, S., and Smith, M., “Life insurance in a portfolio context,” Insurance: Mathematics and Economics 2, 147-57 (1983)).

Thus, there is a need in the industry for a method that links the asset allocation decision with the life insurance purchase decision into one framework by incorporating human capital, which takes into consideration the impact of the investor's bequest motive, objective and/or subjective survival probability, the volatility of the investor's income in correlation to the financial market

### BRIEF DESCRIPTION OF THE DRAWINGS

For the purpose of illustrating the invention, explanatory Figures are provided; it being understood, that this invention is not limited to the information represented by the Figures.

FIG. 1 depicts the relationship between an investor's expected financial capital and human capital over the investor's life cycle.

FIG. 2 is a flow chart depicting the financial capital calculation in an embodiment of the present invention.

FIG. 3 is a flow chart depicting the human capital calculation in an embodiment of the present invention.

FIG. 4 is a schematic illustrating a computer system suitable for carrying out the present invention.

FIG. 5 depicts the relationship between an investor's human capital, insurance demand and financial asset allocation over the investor's life cycle.

FIG. 6 depicts the relationship between an investor's insurance demand and asset allocation across the investor's strength of bequest.

FIG. 7 depicts the relationship between an investor's insurance demand and asset allocation at different risk aversion levels.

FIG. 8 depicts the relationship between an investor's insurance demand and asset allocation at different levels of financial wealth.

FIG. 9 depicts the relationship between an investor's insurance demand and asset allocation at different correlation levels.

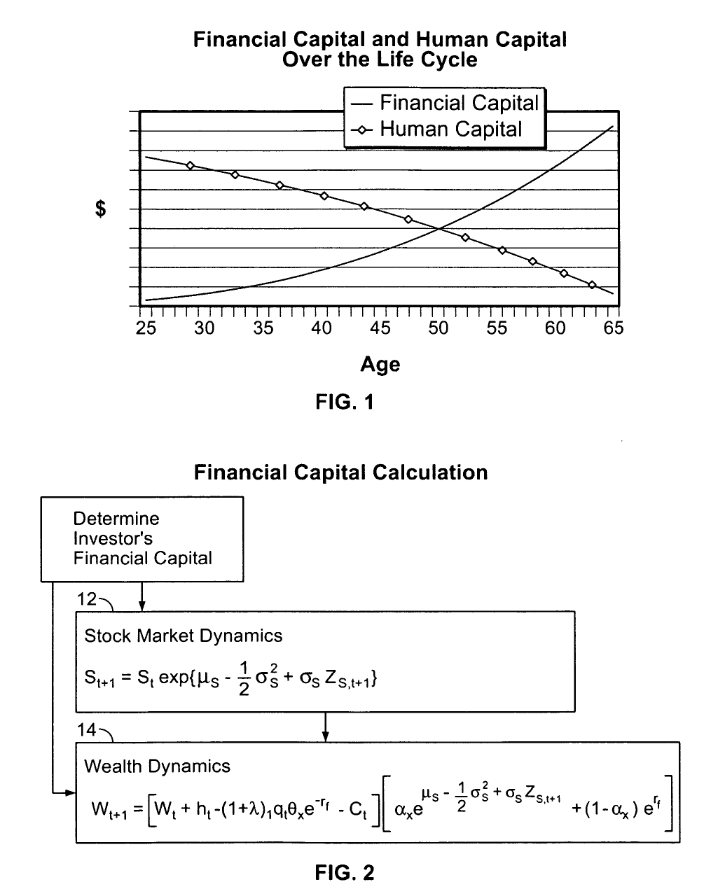

### DETAILED DESCRIPTION

It will be appreciated that the following description is intended to refer to specific embodiments of the invention and is not intended to define or limit the invention, other than in the appended claims. A variety of modifications to the embodiments described will be apparent to those skilled in the art from the disclosure provided herein. Thus, the invention may be embodied in other specific forms without departing from the spirit or essential attributes thereof.

When a value or parameter is given as either a range, preferred range, or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range.

The term “human capital”, as used herein, is meant to refer to the actuarial present financial economic value or future labor income of all future wages, which is a scalar quantity and is dependent upon a number of both subjective or market equilibrium factors.

The term “retirement”, as used herein, is meant to indicate the termination of the human capital income flow and the beginning of the pension phase.

The invention relates to a method, system or medium for linking an investor's human capital with determining the investor's allocation of wealth to the acquisition of assets, life insurance, or both, where the invention accounts for the impact of the investor's bequest motive and objective and/or subjective survival probability as well as the volatility of the investor's income in correlation to the financial market.

In merging asset allocation and human capital with the optimal demand for life insurance, understanding the actuarial factors that impact the pricing of a life insurance contract is important. A number of life insurance product variations are available (i.e., term life, whole life, or universal life), and the system and method of the invention can be adapted to work with any of them. The most fundamental type, the one-year renewable term policy, is used as an example below.

With a one-year renewable term the policy premium is typically paid at the beginning of the year, or on the individual's birthday, and protects the human capital of the insured for the duration of the year. Thus, should the insured person die within the year covered by the purchased policy, the insurance company pays the face value to the beneficiaries, soon after the death or prior to the end of the year. The next year the contract is guaranteed to start anew with new premium payments made and protection received.

The policy premium is typically an increasing function of the desired face value, where the policy premium calculation is represented by the general equation:
P=[q/(1+r)]θ (1)

The premium P is calculated by multiplying the desired face value of the insurance policy θ by the probability of death q, and then discounting by the interest rate factor (1+r). The theory behind equation (1) is the well-known “law of large numbers,” which guarantees that probabilities become percentages when individuals are aggregated. The implicit assumption of equation (1) is that although death can occur at any time during the year (or term), the premium payments are made at the beginning of the year and the face values are paid at the end of the year. From an insurance company's perspective, all of the premiums received from the group of N individuals with the same age (i.e., probability of death q) and face value θ, are co-mingled and invested in an insurance reserve earning a rate of interest r so that at the end of the year, PN(1+r) is partitioned amongst the qN beneficiaries. No savings component or investment component is embedded within the policy premium defined by equation (1). Rather, at the end of the year the survivors lose any claim to the pool of accumulated premiums, since all funds go directly to the beneficiaries.

As an individual ages and the probability of death qₓ increases (denoted by x), the same exact face amount of (face value) life insurance θ will cost more and will induce a higher premium Pₓ, as per the formula. In practice, the actual premium is loaded by an additional factor denoted by (1+λ) to account for commissions, transaction costs, and profit margins (λ denotes the fees and expenses, i.e., actuarial and insurance loading, imposed and charged on a typical life insurance policy) and so the actual amount paid by the insured is closer to P(1+λ), but the underlying pricing relationship driven by the law of large numbers remains the same.

Typically, when purchasing life insurance, individuals conduct a budgeting analysis to determine his or her life insurance demands (i.e., the amount the surviving family and beneficiaries need to replace the lost wages in present value terms). The life insurance demand would be taken as the required face value in equation (1), which would then lead to a premium. Alternatively, one can think of a budget for life insurance purchases, and the policy purchase premium would be determined by equation (1).

The model of the invention will “solve” for the optimal age-varying amount of life insurance denoted by θ, which then induces an age-varying policy payment Pₓ, which maximizes the welfare of the family by taking into account its risk preferences and attitudes toward bequest.

As previously set forth, in the invention an investor can allocate their financial wealth between life insurance and assets. With respect to the allocation of financial wealth to assets it is assumed that there are two asset classes, where an investor can allocate financial wealth to either a risk-free asset (i.e., bonds, which is representatively utilized herein) and a risky asset (i.e., stocks, which is representatively utilized herein). This is consistent with the two-fund separation theorem that is consistent with traditional portfolio theory. Of course, this can always be expanded to multiple asset classes. The investor's objective is to maximize the overall utility of their wealth, which includes utility from the alive state and the dead state. It is also assumed that the investor makes asset allocation and insurance purchase decisions at the start of each period and that labor income is also received at the beginning of each period.

An embodiment of the invention relates to a method for allocating an investor's wealth to at least one asset (e.g., either at least one risky asset and/or at least one risk-free asset) and life insurance comprising:
(a) retrieving a profile of the investor;
(b) determining financial capital available to the investor;
(c) determining a human capital value for the investor;
(d) determining an objective function value for the investor;
(e) maximizing the investor's objective function value; and
(f) allocating an amount of the investor's wealth to at least one risky asset and to fund a life insurance policy.

Retrieving an investor's profile includes gathering information pertinent to determining the investor's available financial capital and human capital value. The investor's profile typically includes, but is not limited to, determining their current age, gender, and either the investor's age or projected age for retirement. The investor's profile may be generated by retrieving the particular data from the investor's employer, one or more record keepers having the requisite information or from the investor himself or herself.

With reference to FIG. 2, determining an investor's available financial capital comprises calculating the value of at least one risky asset in their investment portfolio, illustrated at 12; and calculating the one or more budget constraints or restrictions on the investor's capital, illustrated at 14.

The value of a risky asset is represented by the general equation:

$${S}_{t + 1} = {S}_{t} exp \{ {μ}_{S} - \frac{1}{2} {σ}_{S}^{2} + {σ}_{S} {Z}_{S , t + 1} ) \qquad ( 2 )$$

such that this value follows a discrete version of a Geometric Brownian Motion, where Sₜ denotes the at least one risky asset, μ_{S} denotes the expected return of the risky asset, σ_{S} denotes the standard deviation of the risky asset and Z_{S,t} is an independent random variable and Z_{S,t}˜N(0,1).

The budget constraints or restrictions of an investor's investment portfolio need to be taken into account. These constraints act as limitations of the financial wealth that an investor may commit to the purchase of life insurance, the purchase of at least one asset, of the purchase of both. As a result, the amount of available financial capital is to be discounted by the budget constraints. The budget constraints are represented by the general equation:

$${W}_{t + 1} = [ {W}_{t} + {h}_{t} - ( 1 + λ ) {q}_{t} {θ}_{x} {e}^{- {r}_{f}} - {C}_{t} ] [ {α}_{x} {ⅇ}^{{μ}_{S} - \frac{1}{2} {σ}_{S}^{2} + {σ}_{S}^{2} {Z}_{S , t + 1}} + ( 1 - {α}_{x} ) {e}^{{r}_{f}} ] \qquad ( 3 )$$

Wₜ denotes financial wealth at time t; hₜ denotes the annual labor income; λ denotes the fees and expenses (i.e., actuarial and insurance loading) imposed and charged on a typical life insurance policy; qₜ denotes the objective probabilities of death at the end of the year x+1 conditional on being alive at age x, determined by a given population (i.e., mortality table); θₓ denotes the amount of life insurance; the expected return on the risk-free asset is denoted bye e^{r}^{_{f}} or e^{-r}^{_{f}}; Cₜ denotes the consumption at year t; αₓ denotes the allocation to risky assets; μ_{S} denotes the expected return of the risky asset; σₛ denotes the standard deviation of the return of the risky assets; and Z_{S,t} is an independent random variable and Z_{S,t}˜N(O, 1).

Human capital, though not traded and highly illiquid, should be treated as part of the endowed wealth that must be protected, diversified and hedged. The correlation between human capital and financial capital (i.e., whether you are closer to a bond or a stock) has a noticeable and immediate impact on the demand for life insurance as well as the usual portfolio considerations. A determination of how much life insurance is needed and where financial capital should be invested cannot be solved in isolation. For instance, a person whose income heavily relies on commissions should consider his human capital closer to a stock since the income is highly correlated with the market, which results in great uncertainty in his human capital. Consequently, he should purchase less insurance and invest more financial wealth in bonds. Conversely, a tenured university professor, for example, who considers his/her human capital closer to a bond, purchases more insurance, and invests more financial wealth in stocks.

In between the extremes of classifying an investor as purely a stock or bond, human capital is a diversified portfolio of stocks and bonds, plus any idiosyncratic risks. For example, if a person's human capital is 40% long-term bonds, 30% financial services, and 30% utilities, the unpredictable shocks to future wages have a given correlation structure with the named sub-indices. Accordingly, a tenured university professor could be considered to be a 100% real-return (inflation linked) bond, since shocks to wages, if there are any, would not be linked to any financial sub-index. However, there are difficulties involved in calibrating these variables and some of the parameters relied upon by Davis and Willen are utilized herein for the case numerical examples (Davis, Stephen J. and Willen, Paul, “Occupation-Level Income Shocks and Asset Returns: Their Covariance and Implications for Portfolio Choice”, University of Chicago Graduate School of Business, Working Paper (2000)).

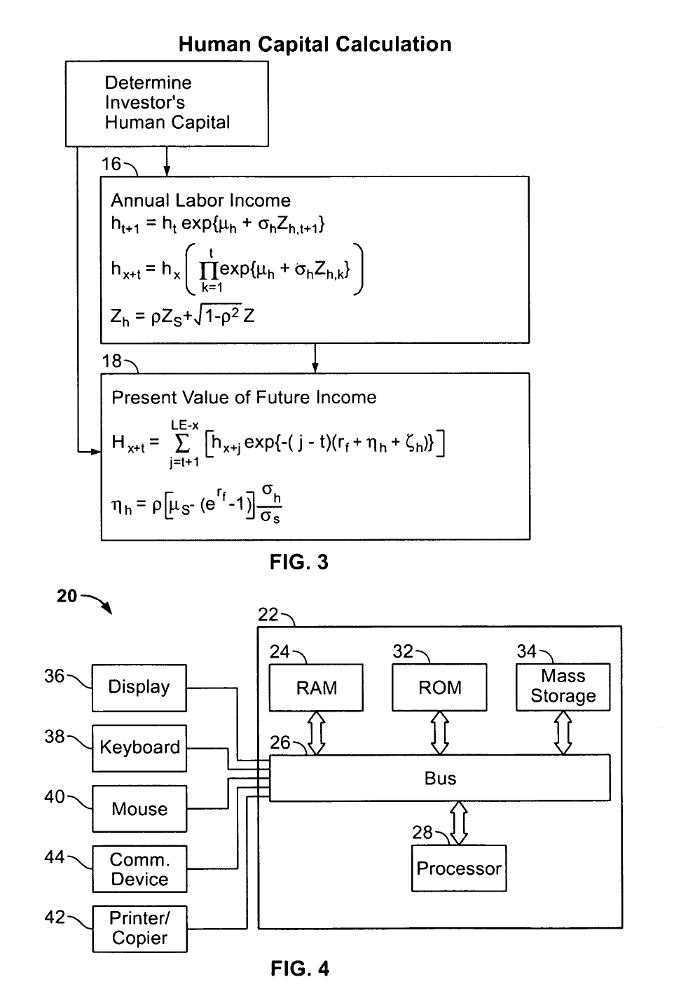

As illustrated in FIG. 3, determination of an investor's human capital comprises calculating their annual labor income, illustrated at 16, and calculating the present value of the investor's future income, illustrated at 18.

Calculating an investor's annual labor income is represented by the general equation:
hₜ₊₁=hₜ exp{μₕ+σₕZ_{h,t+1}} (4)
where labor income hₜ is greater than zero, μₕ and σₕ are the annual growth rate and the annual standard deviation, respectively, of the income process. Z_{h,t} is an independent random variable and Z_{h,t}˜N(0,1).

Thus, based on equation (4), for a person at age x, their income at age x+t is represented by the general equation:

$${h}_{x + t} = {h}_{x} ( {\prod }_{k = 1}^{l} exp \{ {μ}_{h} + {σ}_{h} {Z}_{h , k} \} ) \qquad ( 5 )$$

where hₜ>0, and μₕ and σₕ are the annual growth rate and the annual standard deviation of the income process. Z_{h,k} is an independent random variable and Z_{h,k}˜N(0,1).

Thus, calculating the present value of future income from age t+1 until death is represented by the general formula:

$${H}_{x + t} = {\sum }_{j = t + 1}^{Y - x} [ {h}_{x + j} exp \{ - ( j - t ) ( {r}_{f} + {η}_{h} + {ζ}_{h} ) \} ] \qquad ( 6 )$$

where ηₕ is the risk premium or discount rate for the income process and captures the market risks associated with the income. ζₕ is the discount factor of the human capital calculation which accounts for the illiquidity risk associated with the investor's occupation (a 4 percent discount rate per year is typical). Y is the investor's retirement age, either real or projected and the return on the risk free asset is r_{f}. Furthermore, we regard the expected value of Hₜ (i.e., E[Hₓ₊ₜ]), as the human capital one has at age x+t+1.

The risk premium for the income process (ηₕ) is calculated using the general equation:

$${η}_{h} = ρ [ {μ}_{S} - ( {e}^{{r}_{f}} - 1 ) ] \frac{{σ}_{h}}{{σ}_{S}} \qquad ( 7 )$$

where ρ represents the correlation between the labor income innovation and the return of the risky asset; μₛ is the expected return of the financial markets (the risky asset); r_{f} is the expected return on the risk-free asset; σₕ is the annual standard deviation of the income growth rate; and σ_{S} is the standard deviation of the return on the risky asset. It is assumed that the correlation between the labor income innovation and the return of risky asset is ρ and:
Zₕ=ρZ_{S}+\sqrt{1−ρ²}Z (8)
where, Z is a standard Brownian motion independent of Z_{S}. That is,
Corr(Z_{S},Zₕ)=ρ. (9)

A determination of the functional value comprises determining the utility of bequest and risk aversion of the investor and retrieving the at least one survival probability of the investor. The asset allocation decision affects well-being in both the alive consumption state (Uₐₗᵢᵥₑ) and the dead bequest state (U_{dead}) while the life insurance decision mostly affects the bequest state.

Bequest preference is arguably the most important factor other than human capital when evaluating the life insurance demand (a well-designed questionnaire could help elicit the individual's attitude towards bequest, even though a precise estimate may be hard to obtain). Investors who weight bequest more (higher D) are likely to purchase more life insurance). D denotes the relative strength of the utility of bequest, where individuals with no utility of bequest will have a value of D=0.

The invention also considers an investor's subjective survival probability (1− q̅). Investors with low subjective survival probability will tend to buy more life insurance. This adverse selection problem is well-documented in the insurance literature. The actuarial mortality tables can be taken as a starting point. Life insurance is already priced to take into account the adverse selection.

The function value is represented by the general equation:
(1−D)×(1− q̅ₓ)×Uₐₗᵢᵥₑ[Wₓ₊₁+Hₓ₊₁]+D×( q̅ₓ)×U_{dead}[Wₓ₊₁+θₓ] (10)
such that

$${U}_{alive} ( x ) = {U}_{dead} ( x ) = \frac{{x}^{1 - γ}}{1 - γ} \qquad ( 11 )$$

where for x>0 and γ≠1, and
Uₐₗᵢᵥₑ(x)=U_{dead}(x)=ln(x) (12)
for x>0 and γ=1; where x, Wₓ₊₁, Hₓ₊₁ and θₓ have been described above and γ denotes the risk aversion parameter.

Thus arriving at the objective functional values is done through simulation, where the values of the risky asset is simulated using equation (2). Then Zₕ is simulated through equation (8), which takes into account the correlation between the income innovation and the return of the financial market. Human capital (Hₓ₊₁) is calculated using equations (5) and (6). If the wealth level at age x+1 is less than zero, the wealth is set as equal to zero, to indicate that an investor does not have any remaining wealth. This process is carried out N times.

Thus, based on the above, the objective functional value can then be calculated, which is represented by the general equation:

$${f}_{N} ( {θ}_{x} , {α}_{x} ) = \frac{1}{N} {\sum }_{n = 1}^{N} \{ ( 1 - D ) \times ( 1 - {}_{1}^{}{\overline{q}}{}_{x}^{} ) \times {U}_{alive} [ {W}_{x + 1 , n} + {H}_{x + 1 , n} ] + D \times ( {}_{1}^{}{\overline{q}}{}_{x}^{} ) \times {U}_{dead} [ {W}_{x + 1 , n} + {θ}_{x} ] \} \qquad ( 11 )$$

where the equation accounts for the impact of the investor's bequest motive and objective survival probability and/or subjective survival probability as well as the volatility of the investor's income in correlation to the financial market.

Thus, the investor can determine the optimal amount of life insurance demand (a.k.a. the face value of the life insurance or the death benefit) (θₓ) together with the allocation of wealth (αₓ) to risky assets in order to maximize the year end utility of the total wealth, which is the human capital plus the financial wealth, weighted by the alive and dead states. Therefore, optimization can be express using the equation:

$${max}_{\{ {θ}_{x} , {α}_{x} \}} E \{ ( 1 - D ) \times ( 1 - {\overline{q}}_{x} ) \times {U}_{alive} [ {W}_{x + 1} + {H}_{x + 1} ] + D \times ( {\overline{q}}_{x} ) \times {U}_{dead} [ {W}_{x + 1} + {θ}_{x} ] \} \qquad ( 12 )$$

subject to the budget constraints of Equation (3) such that and

$$\begin{matrix}{θ}_{0} \leq {θ}_{x} \leq \frac{( {W}_{x} + {h}_{x} - {C}_{x} ) {e}^{{r}_{f}}}{( 1 + λ ) {q}_{x}} , & ( 13 ) \\ and & \\ 0 \leq {α}_{x} \leq 1. & ( 14 )\end{matrix}$$

Equation (13) requires the cost (or price) of the term insurance policy to be less than the amount of current financial wealth the client has, and there is a minimum insurance amount (θ₀>0) an investor is required to purchase in order to have a minimum protection from the loss of human capital.

The invention further relates to a system for carrying out the determination of the optimal allocation of an investor's wealth. A representative suitable system is indicated in general at 20 in FIG. 4 and comprises those computers well known in the art, for example a personal computer 22. Typically, the computer system includes a memory 24 (for example either random access memory including DRAM, SDRAM, or other known types of memory) for storing data such as the investor's profile and the plurality of formulas of the invention. The computer also includes a bus 26 and a microprocessor 28 loaded with an operating system and executable instructions for one or more special applications capable of carrying of the invention. The computer also includes electronic read only memory 32 for storing those programs known in the art that are non-volatile and persist after the computer is shut down.

Alternatively, one or more of the computer programs capable of carrying out the invention may be “hard-wired” into the read only memory instead of being loaded as software instructions into the random access memory. The read only memory can comprise electrically programmable read only memory, electrically erasable and programmable read only memory of either flash or nonflash varieties or other sorts of read only memory such as programmable fuse or antifuse arrays.

The computer program for carrying out the invention will be stored or pre-recorded on a machine-readable medium or mass storage device 34 (FIG. 4), such as an optical disk or magnetic hard drive or other known device. The data and formula associated with the invention will typically exist as a data base on the mass storage device but could also reside on a separate database server and be accessed remotely through a network.

The computer system may also be connected to peripheral devices used to communicate with an operator such as, for example a display or monitor 36, a keyboard 38, a mouse 40, a printer and/or copier 42. Additionally, the computer system may also include communication devices 44 such as a modem or a network card to communicate with other computers and equipment, where such communication pathways are preferably secure pathways to protect the confidential nature of certain data.

The computer system may also include a web server acting as a host for a website on which can be displayed a questionnaire or other request for information, which is accessible to an investor and investor's computer either remotely or non-remotely.

### EXAMPLES

An analysis for five representative case studies is performed with respect to the optimal asset allocation and the optimal life insurance coverage. The problem is solved via simulation. There are several key results: 1) investors need to make asset allocation decisions and life insurance decisions jointly; 2) the magnitude of human capital, its volatility, and its correlation with other assets have a significant impact on the two decisions over the life cycle; 3) bequest preferences and the subjective survival probability have a significant impact on insurance demand, but little influence on optimal asset allocation; and 4) conservative investors should invest more in risk-free assets and buy more life insurance.

In the Examples, it is assumed there are two asset classes in which the investor can invest his/her financial capital. Table I provides the capital market assumptions used in all five cases. It is also assumed that the investor is male, wherein his preference toward bequest is one-fourth of his preference toward consumption in the live state, 1−D=0.8 and D=0.2. He is agnostic about his relative health status (i.e., his subjective survival probability is equal to the objective actuarial survival probability). His income is expected to grow with inflation, and the volatility of the growth rate is 5 percent (the salary growth rate and the volatility are chosen mainly to show the implications of the model and are not necessarily representative). His real annual income is $50,000, and he saves 10 percent each year. He expects to receive a pension of $10,000 each year (in today's dollars) when he retires at age 65. His current financial wealth is $50,000. The investor is assumed to follow the constant relative risk aversion (CRRA) utility with a risk aversion coefficient (γ). Finally, the financial portfolio is assumed to be rebalanced and the term life insurance contract is renewed annually (he mortality and insurance loading is assumed to be 12.50%). These assumptions remain the same for all cases. Other parameters such as initial wealth will be specified in each case.

TABLE 1
Capital Market Return Assumptions

| | Compounded Annual | |
|---|---|---|
| | Return | Risk (Standard Deviation) |
| Risk-Free (Bonds) | 5% | — |
| Risky (Stocks) | 9% | 20% |
| Inflation | 3% | — |

### Example 1

### Human Capital, Financial Asset Allocation, and Life Insurance Demand Over Lifetime

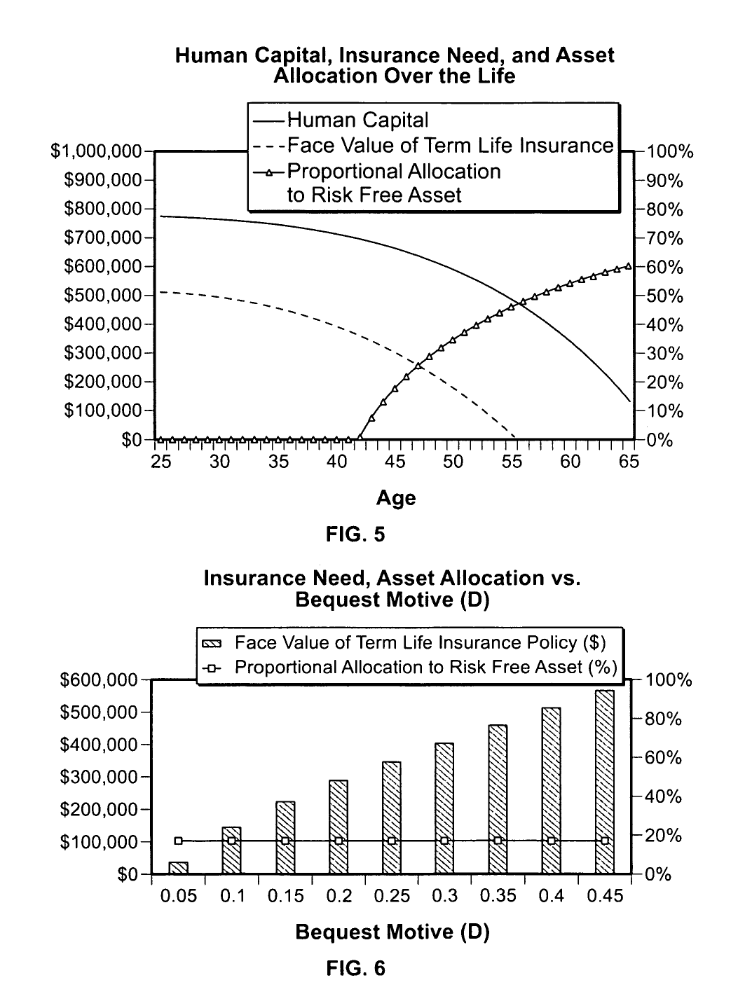

In this case, it is assumed that the investor has a moderate risk aversion (relative risk aversion of 4). Also, the correlation between the investor's income and the market return (risky asset) is assumed to be 0.20 (Davis and Willen (2000) estimated the correlation between labor income and equity market returns using the Current Occupation Survey. They find that correlation between equity returns and labor income typically lies in the interval from −0.10 to 0.20). For a given age, the amount of insurance the investor should purchase can be determined by his consumption/bequest preference, risk tolerance, and financial wealth. His expected financial wealth, human capital, and the derived optimal insurance demand over the investor's life (from age 25 to 65) are presented in FIG. 5.

Several results are worth noting. First, human capital gradually decreases as the investor gets older and the remaining number of working years gets smaller. Second, the amount of financial capital increases as the investor ages; this is the result of growth of existing financial wealth and additional savings the investor makes each year. The allocation to risky asset decreases as the investor ages. This result is due to the dynamic between human capital and financial wealth over time. When an investor is young, the investor's total wealth is dominated by human capital. Since human capital in this case is less risky than the financial risky asset, young investors will invest more financial wealth into risky assets to offset the impact of human capital on the overall asset allocation. As the investor gets older, the allocation to risky assets is reduced as human capital gets smaller. Finally, the insurance demand decreases as the investor ages, as the primary driver of the insurance demand is the human capital. The decrease in the human capital reduces the insurance demand. The following cases will vary the investor's preference of bequest, risk preference, and existing financial wealth to illustrate the impact of these variables on the investor's optimal asset allocation and life insurance purchases.

### Example 2

### Strength of Bequest Motive

This case shows the impact of bequest motives on the optimal decisions on asset allocation and insurance demand. In the case, it is assumed the investor is at age 45 and has an accumulated financial wealth of $500,000. The investor has a moderate risk aversion coefficient of 4. The optimal allocations to the risk-free asset and the optimal insurance demands across various bequest levels are presented in FIG. 6.

It can be seen that the insurance demand increases as the bequest motive gets stronger, i.e., the D gets larger. This results because an investor with a stronger bequest motive is more concerned about his/her heirs and has the incentive to purchase a larger amount of insurance to hedge the loss of human capital. On the other hand, there is almost no change in the proportional allocation to risk-free asset at different strengths of bequest motive. This indicates that the asset allocation is primarily determined by risk tolerance, returns on risk-free and risky assets, and human capital. This case shows that bequest motive has a strong impact on insurance demand, but little impact on optimal asset allocation. In this model, subjective survival probability has similar impact on the optimal insurance need and asset allocation as the bequest motive (D). When subjective survival probability is high, the investor will buy less insurance.

### Example 3

### Risk Tolerance

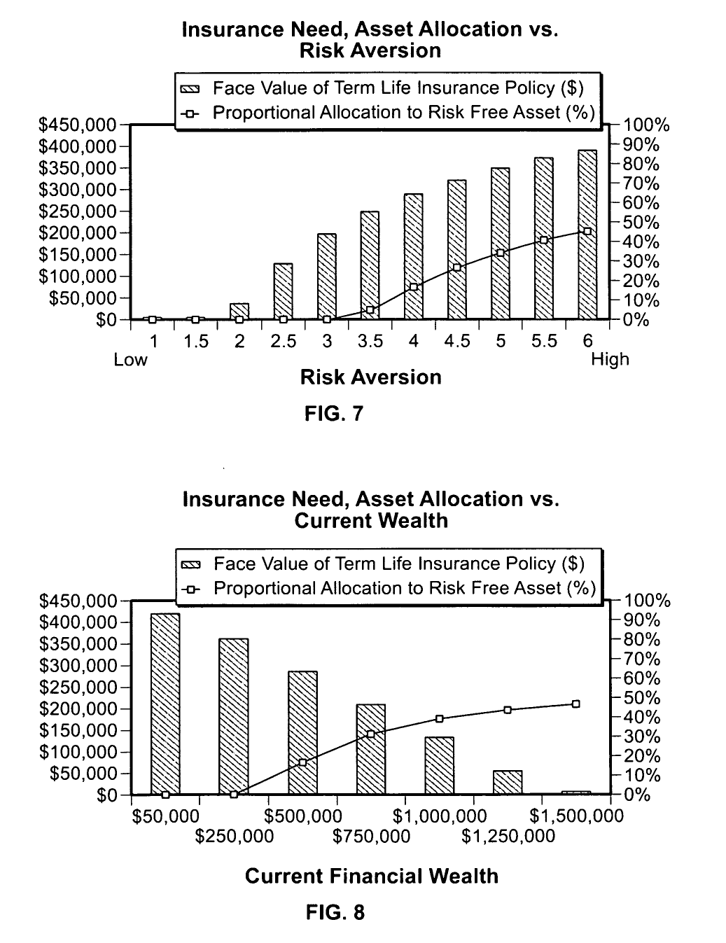

This case shows the impact of the different degrees of risk aversion on the optimal decisions on asset allocation and insurance demand. In this case, it is again assumed the investor is at age 45 and has accumulated a financial wealth of $500,000. The investor has a moderate bequest level, i.e., D=0.2. The optimal allocations to risk-free asset and the optimal insurance demands across various risk aversion levels are presented in FIG. 7.

The allocation to the risk-free asset increases with the investor's risk aversion level. Actually, the optimal portfolio is 100 percent in stocks for risk aversion levels less than 2.5. The optimal amount of life insurance has a very similar pattern. The optimal insurance demand increases with risk aversion. For a moderate investor (a CRRA risk aversion coefficient 4), the optimal insurance demand is about $290,000, which is roughly six times the current income of $50,000 (This result is very close to the typical recommendation by financial planners; i.e., purchase a term life insurance policy that has a face value four to seven times one's current income. (See, for example, Todd (2004)). Therefore, conservative investors should invest more in risk-free assets and buy more life insurance, compared to aggressive investors.

### Example 4

### Financial Wealth

This case shows the impact of the different amounts of current financial wealth on the optimal asset allocation and insurance demand. The investor's age is held at 45 and the risk preference and the bequest motive at the moderate levels (a CRRA risk aversion coefficient 4 and bequest level 0.2). The optimal asset allocations to risk-free asset and the optimal insurance demands for various financial wealth levels are presented in FIG. 8.

First, it can be seen that the optimal allocation to the risk-free asset increases with the initial wealth. This may seem inconsistent with the CRRA utility function, since the CRRA utility function implies the optimal asset allocation does not change with the amount of the investor's wealth. However, it needs to be noted that the wealth includes both financial wealth and human capital. In fact, this is an example of the impact of human capital on the optimal asset allocation. An increase in financial wealth not only increases the total wealth, but also reduces the percentage of total wealth represented by human capital. In this case, human capital is less risky than the risky asset, where the income has a real growth rate of 0% and a standard deviation of 5%, yet the expected real return on stock is 8% and the standard deviation is 20%.). When the initial wealth is low, the human capital dominates the total wealth and the allocation. As a result, to achieve the target asset allocation of a moderate investor, say an allocation of 60 percent risk-free asset and 40 percent risky asset, the closest allocation is to invest 100 percent financial wealth in the risky asset, since the human capital is illiquid. With the increase in the initial wealth, the asset allocation is gradually adjusted to approach the target asset allocation a moderate risk-averse investor desires.

Second, the optimal insurance demand decreases with financial wealth. This result can be intuitively explained through the substitution effects between financial wealth and life insurance. In other words, with a large amount of wealth in hand, one has less demand for insurance, since the loss of human capital has a much lower impact on the well-being of one's heirs. The optimal amount of life insurance decreases from over $400,000, when the investor has little financial wealth, to almost zero, when the investor has $1.5 million in financial assets.

Thus, for a typical investor whose human capital is less risky compared to the stock market, the optimal asset allocation is more conservative and the life insurance demand is smaller for investors with more financial assets.

### Example 5

### Correlation Between Wage Growth Rate and Stock Returns

In this case, the impact of the correlation between the shocks to wage income and the risky asset returns is examined. In particular, we want to evaluate the life insurance and asset allocation decision for investors with highly correlated income and human capital. This can happen when the investor's income is closely linked to his employer's company stock performance, or where the investor's compensation is highly influenced by the financial market (e.g., the investor works in the financial industry).

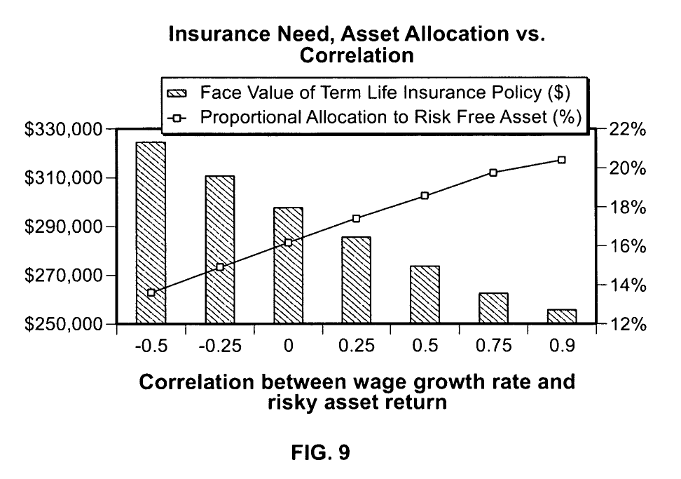

Again, the investor's age is held at 45 and the risk preference and the bequest motive at the moderate level. The optimal asset allocations to the risk-free asset and the optimal insurance demands for various financial wealth levels are presented in FIG. 9.

The optimal allocation becomes more conservative (i.e., more allocation to risk-free asset) as the income and stock market return become more correlated. One way to look at this is that a higher correlation between the human capital and the stock market results in less diversification, thus a higher risk of the total portfolio (human capital plus financial capital). To reduce this risk, an investor will invest more financial wealth in the risk-free asset. The optimal insurance demand decreases as the correlation increases. Life insurance is purchased to protect human capital for the family and loved ones. As the correlation between the risky (stock) asset and the income flow increases, the ex ante value of the human capital to the surviving family becomes lower. Therefore, this lower human capital valuation induces a lower demand for insurance. Also, less money spent on life insurance also indirectly increases the amount of financial wealth the investor can invest. This also allows the investor to invest more in risk-free assets to reduce the risk associated with the total wealth.

In summary, the optimal asset allocation becomes more conservative and the amount of life insurance becomes less, as wage income and the stock market returns become more correlated.

What is claimed is:

1. A method for allocating an investor's wealth to at least one risky asset and life insurance comprising:
(a) retrieving a profile of the investor;
(b) determining financial capital available to the investor;
(c) determining a human capital value for the investor;
(d) determining an objective function value for the investor;
(e) maximizing the investor's objective function value; and
(f) allocating an amount of the investor's wealth to the at least one risky asset and to life insurance.

2. The method according to claim 1, wherein retrieving the investor's profile further comprises:
(a1) determining a current age of the investor;
(a2) determining a gender of the investor;
(a3) determining a retirement age of the investor.

3. The method according to claim 1, wherein the at least one risky asset comprises a stock.

4. The method according to claim 1, wherein determining the investor's financial capital further comprises:
(b1) calculating a value of the at least one risky asset; and
(b2) calculating a plurality of budget constraints on the investor's capital.

5. The method according to claim 1, wherein determining the investor's human capital further comprises:
(c1) calculating a labor income of the investor; and
(c2) calculating a present value of the investor's future income.

6. The method according to claim 1, wherein determining the plurality of objective function values further comprises:
(d1) determining a utility of bequest for the investor's;
(d2) retrieving at least one survival probability of the investor; and
(d3) determining a risk tolerance for the investor.

7. The method according to claim 6, wherein the utility of bequest of the investor is greater than zero.

8. The method according to claim 6, wherein the utility of bequest of the investor is zero.

9. The method according to claim 6, wherein the at least one probability of survival is selected from the group consisting of an objective probability of survival for the investor and a subjective probability of survival for the investor.

10. The method according to claim 6, wherein the risk tolerance of the investor is greater than zero.

11. The method according to claim 1, wherein steps (a)-(d) are repeated N times.

12. The method according to claim 11, wherein N is 20000.

13. A system for allocating an investor's wealth to at least one risky asset and life insurance comprising: a memory for storing a profile of the investor, financial capital available to the investor, a human capital value for the investor, an objective function value for the investor, a maximized objective function value for the investor, and an allocated an amount of the investor's wealth to at least one risky asset and to life insurance; and a processor coupled to the memory to retrieve the stored profile of the investor; the stored financial capital available to the investor; the stored human capital value for the investor; the stored objective function value for the investor; the stored maximized objective function value for the investor; and the stored allocated an amount of the investor's wealth to at least one risky asset and to life insurance.

14. The system according to claim 13, where the processor, in retrieving the investor's profile, determines the current age of the investor; determines the gender of the investor; and determines the retirement age of the investor.

15. The system according to claim 13, where the processor, in determining the investor's financial capital, calculates a value of the at least one risky asset; and calculating a plurality of budget constraints on the investor's capital.

16. The system according to claim 13, where the processor, in determining the investor's human capital, calculates a labor income of the investor; and calculates a present value of the investor's future income.

17. The system according to claim 13, where the processor, in determining the plurality of objective function values, determines a utility of bequest for the investor's; retrieves at least one survival probability of the investor; and determines a risk tolerance for the investor.

18. The system according to claim 13, wherein the system is connected to at least one peripheral device from the group consisting of a display or monitor, a keyboard, a mouse, a printer and/or copier.

19. The system according to claim 13, wherein the system further comprises a communication device from the group consisting of a modem and a network card.

20. The system according to claim 13, wherein the system further comprises a web server acting as a host for a website on which can be displayed a questionnaire or other request for information, which is accessible to an investor and an investor's computer either remotely or non-remotely.

21. A machine-readable medium on which has been prerecorded a computer program, which when executed by a processor, performs method comprising: retrieves a profile of an investor; determines financial capital available to the investor; determines a human capital value for the investor; determines an objective function value for the investor; maximizes the investor's objective function value; and allocates an amount of the investor's wealth to the at least one risky asset and to life insurance.

22. The medium according to claim 21, wherein the retrieving the investor's profile further comprises: determining a current age of the investor; determining a gender of the investor; determining a retirement age of the investor.

23. The medium according to claim 21, wherein determining the investor's financial capital further comprises: calculating a value of the at least one risky asset; and calculating a plurality of budget constraints on the investor's capital.

24. The medium according to claim 21, wherein determining the investor's human capital further comprises: calculating a labor income of the investor; and calculating a present value of the investor's future income.

25. The medium according to claim 21, wherein determining the plurality of objective function values further comprises: determining a utility of bequest for the investor's; retrieving at least one survival probability of the investor; and determining a risk tolerance for the investor.
